(19) United States
(12) Patent Application Publication
(10) Pub. No.: US 2008/0023092 A1
(43) Pub. Date: Jan. 31, 2008

(54) Method For Designing And Implementing Improved Longitudinal Flexibility Multilayered Pipeline

(76) Inventor: Assaf Klar, Nofit (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/461,005

(22) Filed: Jul. 31, 2006

(51) Int. Cl. F16L 1/00

(52) U.S. Cl. 138/105; 138/108; 138/112

(57) ABSTRACT

The present invention provides a new method for designing a multi layered pipe highly resilient to longitudinal bending, wherein the layer pipe includes an inner pipe, an outer pipe, and a separating layer. According to one embodiment the method includes the following of: determining the preferred ratio between inner and outer pipe radiuses, evaluating the external pressure developed by the surrounding soil in accordance with simplified linear model, calculating preferred stiffness and elastic for the separating material according to evaluated external pressure soil properties and determining the preferred composition of separating material according to calculated radiuses and calculated stiffness and elastic.

### FIELD OF INVENTION

The invention relates to co-centric multilayer pipes comprising one or more inner pipes surrounded by a middle layer of a softer material, and an outer pipe enclosing said middle layer.

### BACKGROUND OF INVENTION

Pipelines are important lifelines of modern civilization, allowing the continuous supply of water, gas and oil. The failure of a pipeline due to ground displacements may cause economical and environmental damages. These displacements may result due to variety of reasons: heave, earthquake, landslides, seasonal water content changes, near by construction, water leaks, liquefactions etc.

Ground displacements might occur for various reasons. Local ground displacements occur due to ground liquefactions or landslides. When saturated sand is subjected to ground vibrations, it tends to compact and decrease in volume; if drainage is unable to occur, the tendency to decrease in volume results in an increase in pore water pressure, and if the pore water pressure builds up to the point of which it is equal to the overburden pressure, the effective stress becomes zero, the sand loses its strength completely, and it develops a liquefied state. One approach for reducing the risk associated with liquefactions or landslides events is by rerouting of pipelines around the problem during early repairs. Another approach aimed for reducing said risks is by increasing the seismic performance by soil improvement. Such related methods includes the densification of otherwise loose soil, the drainage and dissipation of excess pore water pressure, the confinement and limit lateral flow of the soil, and the physical or chemical modification of the soil to increase its strength.

Another type of ground displacement is the faulting. Seismic activity occurring at the boundaries of two or more tectonic plates resulting from their general motion may cause stress to accumulate on faults and lead to rapid energy release and earthquakes. One approach, aimed for reducing such mitigating fault rapture risks, is by orienting pipelines in a specific direction relative to the fault. Pipeline is then placed at the position relative to the fault direction such that its movement would result in minimum straining of the pipe.

Another approach for reducing said risks concentrates on the pipe itself, rather than on modification of the soil around it or the direction of its loading. Such methods use high strength and high ductility materials in conjunction with flexible joints. An isolated multi-layered pipe can serve as a good example.

A good example for an isolated pipe is the co-extruded multilayer plastic pipe. It is an isolated pipe comprising one thin-walled inner pipe and an outer pipe and between them middle layer of a softer material than the inner pipe. It can be used, for example, as underground drain pipes, pressure pipes and cable ducts. These types of pipes are more complicated to manufacture than conventional single-layer pipes, but may have better mechanical properties. U.S. Pat. No. 6,176,269, incorporated by reference herein, describes such pipes.

One known problem with isolated pipes is their limited longitudinal flexure capacity. Ground displacements may cause extreme pressure on certain areas along these pipes, thereby risking the inner pipe continuity. There is a demand for isolated pipes with a proper longitudinal flexibility to be able to safely keep continuity of inner pipe under such external stress.

### SUMMARY OF INVENTION

The object of the present invention is to provide a co-extruded multi-layer pipe reducing the longitudinal flexure (longitudinal bending) risk to pipeline due to ground displacement, thereby supplying a more efficient protection to the inner pipe than in prior art solutions. The present invention does not deal with any axial or cross sectional mechanical properties of the pipe.

A further object of the present invention is to provide a co-extruded multilayer pipe which has better mechanical properties, than those of the corresponding known pipes.

According to the invention, the essential part that carries the fluids (e.g. gas, oil, water) is the inner pipe hence its integrity is of importance. This part is protected by softer outer layers, i.e. layers which are more easily deformed, whereby the adhesive forces between the interfaces of all the layers are as small as possible and adjustable. The inner pipe thus remains circular and undamaged even if the outer pipe becomes oval as a result of compression or even breaks as a result of longitudinal pressure. The outer pipe exists to allow sufficient support for the soil under static conditions, and its integrity in the event of an earthquake is not important (i.e. cracks may develop in it). In essence, the outer pipe should have sufficient cross sectionals stiffness to prevent soil collapse, but no special requirement for longitudinal bending or axial stiffness. The separating material properties are function of the ratio of diameters of inner and outer pipe, and the properties of the soil surrounding the pipe.

According to one embodiment, the separating layer may be composed of inhomogeneous or anisotropic matter or contain multiple zones, relatively small that are filled with void. The nature of the separating material should be instantiated by the mechanical demands of the location, such as the soil type and geological conditions.

### BRIEF DESCRIPTION OF DRAWINGS

FIG. 1 is a longitudinal sectional view of a multilayer plastic pipe of the invention comprising one inner pipe

FIG. 2 is a longitudinal sectional scheme of a mechanical equivalent system.

### DETAILED DESCRIPTION

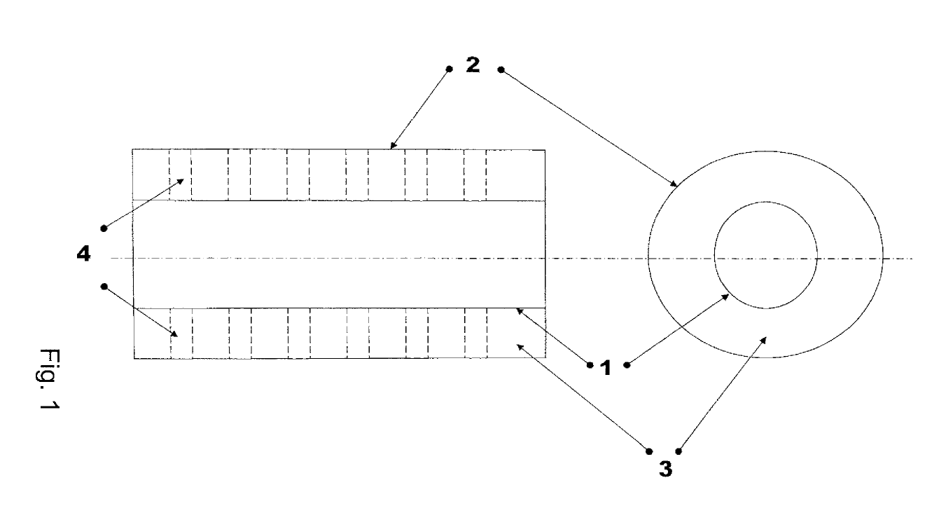

FIG. 1 illustrates the pipe principle components. The pipe comprises an inner pipe (1), an outer pipe (2), and a separating layer (3) of relatively softer matter. According to the present invention the separating layer can be composed any of inhomogeneous or anisotropic matter. For example, separating layer may consist of small void volumes (4).

Choosing the proper combination of materials composing the separating layer could be a complicated task. The separating layer must be able to support the longitudinal pressure developed along the pipe, in order to protect its continuity. The magnitude of the pressure is constituted by the nature of the soil and its potential displacements. The separating layer should be able to absorb part of this pressure and allow flexible movements of both inner and outer layers. The materials composing this layer must have the proper physical stiffness and elastic properties, enabling said functionality. These properties can be defined by the Young's modulus. Young's modulus is the measure of stiffness for a given material measured in N/m². It can be defined as the ration of stress to corresponding strain. This rate can be experimentally determined from the gradient of a stress-strain curve created during tensile tests conducted on a sample of said material.

The pressure magnitude developed on the outer pipe due to ground displacements can be estimated using a simplyfing model describing a system of springs. With this model, the complex soil pressure is reffered to as an equivalent discrete set of springs, connecting between the outer pipe, inner pipe and external static points. A known and relativly simple solution for the linear force generated by a spring enables the development of a set of equations solving the original, more complex problem. Furthemore, external soil pressure is also reflected by the separating layer. A model of equivalent springs can be used to evaluate the pressure magnitude derived from the more complex system, thereby enabling to obtain the proper Young's modulus needed for the seperating layer, for a given external pressure.

The external pressure developed by the surrounding soil can be estimated using simplifying linear models. One commmon model is using the linear subgrade coefficient, where an ampirical evaluation of the soil propery is obtained. A coefficient of subgrade reaction is determined by the measuring of the California Bearing Ratio (CBR) test, which is a simple penetration test for evaluation of the mechanical strength of road subgrades. Another common model is using the linear Young's module evaluation, previously discussed.

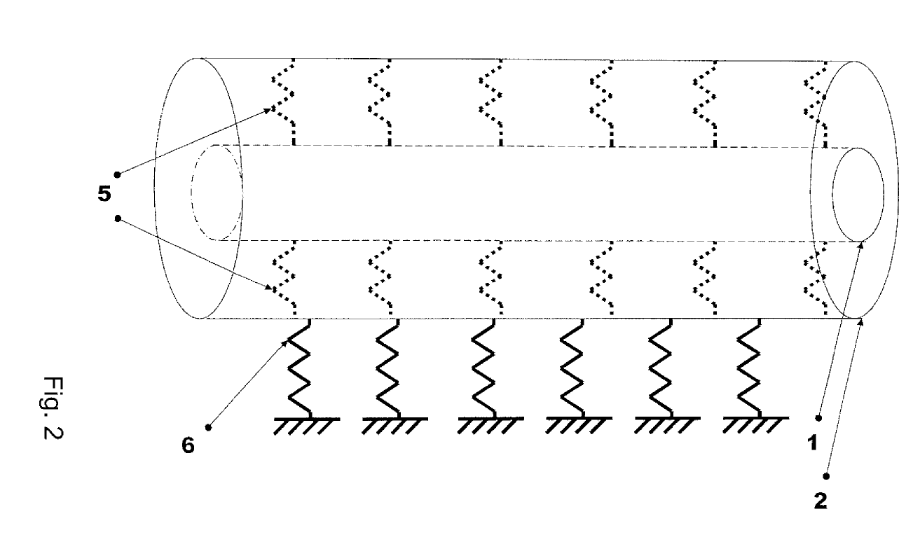

FIG. 2 illustrates the mechanical properties of the pipe wherein the bending forces developed by the separating material are equivalent to said system of springs (5) connected between inner (1) and outer (2) pipes and the bending forces developed by the soil on the outer pipe (2) are equivalent to a system of springs (6) connected between the outer pipe and static points.

The separating material properties are instantiated by the ratio of diameters of both inner and outer pipe, and the properties of the soil surrounding the pipe. A condition is set on the representative Young's modulus, E_{Y}^{R} for the separating material which may be calculated as:

$${E}_{Y}^{R} = {\int }_{V} {E}_{Y} d v = {\int }_{0}^{2 π} d θ {\int }_{{r}_{i}}^{{r}_{o}} r d r {\int }_{0}^{{L}_{p}} d x \cdot {E}_{Y}$$

where E_{Y} is the distribution of Young's modulus (Young's modulus per volume unit) of the different materials composing the separating materials (e.g. if voids are involved than EY takes the value of zero for them), rᵢ and rₒ are the radiuses of the inner and outer pipe respectively, and Lₚ is any section of the pipeline with minimum length of two meters. The demand for a maximum value of E_{Y}^{R} is a function of the surrounding soil properties and the ratio of inner to outer pipe radiuses. The following example demonstrates the calculation of the equivalent Young's modulus for two different materials:

In our example, the radius of the inner pipe is 5 cm and the outer radius is 10 cm. The separating layer composed of two different materials: The first one has the Young's modulus value of E_{Y}=3000 kN/m² per volume unit (Polystyrene) and it fills part of the volume: from r=5 cm to r=6 cm. The second material has the Young's modulus value of E_{Y}=2000 kN/m² per volume unit (Polyethylene terephthalate) and it fills part of the volume: from r−6 cm to r−10 cm. The total Young's modulus for the entire separating material should than be:

$${E}_{Y}^{R} = {\int }_{V} {E}_{Y} d v = {10}^{3} \cdot ( {\int }_{0}^{2 π} d θ {\int }_{0.05}^{0.06} r d r {\int }_{0}^{2} d x \cdot 3 + {\int }_{0}^{2 π} d θ {\int }_{0.06}^{0.1} r d r {\int }_{0}^{2} d x \cdot 2 ) \approx 100 [ k N / {m}^{2} ]$$

Inner and outer pipe radiuses are commonly determined by the physical requirements of the problem. Inner pipe radius, for example, can be determined by the minimum fluid capacity planned to flow through it. In such cases, the separating layer's materials properties are instantiated by the total Young's modulus calculation previously discussed. Nevertheless, there might be different scenarios, when the separating layer's materials are given, and the pipe radiuses needed to be obtained. In such cases, the calculation previously discussed, should also be used, with the relevant adjustments. If, for example, the Young's modulus is given with the value of E_{Y}=2000 kN/m² (Polyethylene terephthalate) per volume unit, and the total Young's modulus E_{Y}^{R}=100 kN/m², then the general formula would be:

$${E}_{Y}^{R} = {\int }_{V} {E}_{Y} d v = {10}^{3} \cdot \text{(} {\int }_{0}^{2 π} d θ {\int }_{ri}^{ro} r d r {\int }_{0}^{2} d x \cdot 2 = 100 [ k N / {m}^{2} ]$$

and the radiuses would be:

$${r}_{o}^{2} - {r}_{i}^{2} = \frac{25}{1000 π} \approx \frac{8}{1000} {m}^{2}$$

A mathematical model analyzing the physical configuration presented in FIG. 2 can be obtained. A linear elastic solution for the response of an isolated pipeline due to surface fault is given in the following Tables (1, 2), wherein the properties and configuration of the separating materials should be such that it obtains a representative value smaller than the one stated in said tables.

Figures in table 1 relates to the subgrade coefficient evaluation attributed to the soil, where each item in the table relates to the subgrade modulus and the ratio of inner and outer pipes radiuses. The subgrade modulus can be calculated using the relation K=kB, where k is the coefficient of subgrade reaction, measured in kN/m² (kN represents the magnitude of force given in kilo Newtons) and B=2 ro (where ro is the radius of outer pipe given in meters). If, for example, the soil's subgrade coefficient measured to be 10,000 kN/m² , the outer pipe radius is 10 cm (10⁻¹ meter ) and the inner pipe radius is 5 cm, then, K=10000 2·10⁻¹=2000 kN/m² and the proper item value in table 1 for these values is equal to 299 kN M². It means that the Young's modulus, E_{Y}^{R} for the separating material must me less than (or equal to) 299 kN/m².

Figures in table 2 relates to the Young's modulus evaluation attributed to the soil, where each item in the table relates to both soil's Young's modulus and the ratio of inner and outer pipes radiuses. If, for example, the soil's Young's modulus equivalent value measured to be 10,000 kN/m², the outer pipe radius is 10 cm (10⁻¹ meter) and the inner pipe radius is 5 cm, then the proper item value in table 2 for these values is equal to 449 kN/M² . It means that the Young's modulus, E_{Y}^{R} for the separating material must be less than (or equal to) 449 kN/m².

If the soil behaves nonlinear, an equivalent linear stiffness for displacement of 3 cm should be considered. It means that the parameters representing soil properties must be evaluated accordingly.

TABLE 1
Subgrade modulus of the soil K[kN/m2]

| | | 1000 | 2000 | 4000 | 8000 | 15000 | 30000 | 50000 | 100000 | 200000 |
|---|---|---|---|---|---|---|---|---|---|---|
| ro/ri | 1 | 0 | 0 | 0 | 0 | 0 | 0 | 0 | 0 | 0 |
| | 1.2 | 39 | 77 | 155 | 310 | 581 | 1162 | 1937 | 3874 | 7749 |
| | 1.4 | 72 | 143 | 287 | 574 | 1076 | 2152 | 3586 | 7172 | 14345 |
| | 1.6 | 101 | 201 | 402 | 805 | 1509 | 3017 | 5029 | 10058 | 20116 |
| | 1.8 | 126 | 253 | 505 | 1010 | 1895 | 3789 | 6316 | 12631 | 25262 |
| | 2 | 150 | 299 | 598 | 1196 | 2243 | 4487 | 7478 | 14956 | 29912 |
| | 2.2 | 171 | 342 | 683 | 1366 | 2562 | 5124 | 8539 | 17079 | 34158 |
| | 2.4 | 190 | 381 | 761 | 1523 | 2855 | 5710 | 9516 | 19032 | 38065 |
| | 2.6 | 208 | 417 | 834 | 1667 | 3126 | 6253 | 10421 | 20842 | 41684 |
| | 2.8 | 225 | 451 | 901 | 1802 | 3379 | 6758 | 11264 | 22528 | 45046 |
| | 3 | 241 | 482 | 964 | 1928 | 3616 | 7232 | 12053 | 24105 | 48211 |

TABLE 2
Young's Modulus of the soil [kN/m2]

| | | 1000 | 2000 | 4000 | 8000 | 15000 | 30000 | 50000 | 100000 | 200000 |
|---|---|---|---|---|---|---|---|---|---|---|
| ro/ri | 1 | 0 | 0 | 0 | 0 | 0 | 0 | 0 | 0 | 0 |
| | 1.2 | 58 | 116 | 232 | 465 | 872 | 1743 | 2906 | 5811 | 11623 |
| | 1.4 | 108 | 215 | 430 | 861 | 1614 | 3228 | 5379 | 10759 | 14345 |
| | 1.6 | 151 | 302 | 603 | 1207 | 2263 | 4526 | 7544 | 15087 | 30174 |
| | 1.8 | 189 | 379 | 758 | 1516 | 2842 | 5684 | 9473 | 18947 | 37893 |
| | 2 | 224 | 449 | 897 | 1795 | 3365 | 6730 | 11217 | 22434 | 44868 |
| | 2.2 | 256 | 512 | 1025 | 2049 | 3843 | 7685 | 12809 | 25618 | 51237 |
| | 2.4 | 285 | 571 | 1142 | 2284 | 4282 | 8565 | 14274 | 28549 | 57097 |
| | 2.6 | 313 | 625 | 1251 | 2501 | 4690 | 9379 | 15632 | 31263 | 62527 |
| | 2.8 | 338 | 676 | 1352 | 2703 | 5069 | 10138 | 16896 | 33792 | 67584 |
| | 3 | 362 | 723 | 1446 | 2893 | 5424 | 10847 | 18079 | 36158 | 72316 |

What claimed is:

1. A method for designing a multi layered pipe highly resilient to longitudinal bending, wherein the layer pipe includes an inner pipe, an outer pipe, and a separating layer, said method comprising the steps of:
a. determining the preferred ratio between inner and outer pipe radiuses;
b. evaluating the external pressure developed by the surrounding soil in accordance with simplified linear model;
c. calculating preferred stiffness and elasticity for the separating material according to evaluated external pressure soil properties;
d. determining the preferred composition of separating material according to determined radiuses and calculated stiffness and elastic.

2. The method of claim 1 wherein the soil properties include the nature of the soil, its various displacements, and geological conditions

3. The method of claim 1 wherein the simplified linear model is represent by model of springs connecting between outer pipe, inner pipe and external static points.

4. The method of claim 1 wherein the simplified linear model is the linear subgrade coefficient.

5. The method of claim 1 wherein the preferred longitudinal stiffness calculation is based on Young's modulus defining the as the ration of stress to corresponding strain.

6. The method of claim 1 wherein the composition of separating material is computed in accordance with mathematical formula expressing the relation between the radiuses ratio, stiffness of material composing the separating layer.

7. The method of claim 1 wherein the separating layer is composed of inhomogeneous or anisotropic matter.

8. The method of claim 1 wherein the determination of radiuses ratio is performed in accordance with soil properties and separating material stiffness.

9. A pipe construction of a multi layered design highly resilient to longitudinal bending, said layer pipe including an inner pipe, an outer pipe, and a separating layer, wherein the separating material composition is determined in accordance with preferred stiffness and preferred ratio between inner and outer pipe radiuses, and wherein said stiffness calculation is based on evaluated pressure developed by the surrounding soil and soil properties using a simplified linear model.

10. The pipe construction of claim 9 wherein the soil properties include the nature of the soil, its various displacements, and geological conditions

11. The pipe construction of claim 9 wherein the simplified linear model is represented by a model of springs connecting between outer pipe, inner pipe and external static points.

12. The pipe construction of claim 9 wherein the simplified linear model is the linear subgrade coefficient.

13. The pipe construction of claim 9 wherein the preferred longitudinal stiffness calculation is based on Young's modulus defining the ration of stress to corresponding strain.

14. The pipe construction of claim 9 wherein the composition of separating material is computed in accordance with mathematical formula expressing the relation between the radiuses ratio, stiffness of material composing the separating layer.

15. The pipe construction of claim 9 wherein the separating layer is composed of inhomogeneous or anisotropic matter.

16. The pipe construction of claim 9 wherein the determination of radiuses ratio is performed in accordance with soil properties and separating material stiffness
